(19) United States
(12) Patent Application Publication
(10) Pub. No.: US 2024/0220789 A1
(43) Pub. Date: Jul. 4, 2024

(54) VIRTUAL TRAINING FOR AUTONOMOUS VEHICLE OPERATIONS PERSONNEL

(71) Applicant: GM Cruise Holdings LLC, San Francisco, CA (US)

(72) Inventors: Kenneth Ferguson, Scottsdale, AZ (US); Jeffrey Brandon, Phoenix, AZ (US); Jason Yang, Fremont, CA (US)

(21) Appl. No.: 18/092,906

(22) Filed: Jan. 3, 2023

(51) Int. Cl. G06N 3/08

(52) U.S. Cl. CPC G06N 3/08

(57) ABSTRACT

The present disclosure generally relates to autonomous vehicle (AV) training, more specifically, to AV training in a collaborative synthetic environment (e.g., a metaverse). In some aspects, the present disclosure provides a process for collecting road data representing a real-world environment encountered by an autonomous vehicle and generating, using the road data, a synthetic environment representative of the real-world environment. In some aspects, the process can further include steps for establishing a connection between the synthetic environment and a remote device, wherein the remote device, and receiving a set of instructions from a user for interacting with the synthetic (virtual) environment. In some aspects, the process can further include steps for modifying the synthetic environment based on instructions received from the user.

### BACKGROUND

### 1. Technical Field

The present disclosure generally relates to autonomous vehicle (AV) training, more specifically, to AV training in a synthetic environment.

### 2. Introduction

Autonomous vehicles (AVs) are vehicles having computers and control systems that perform driving and navigation tasks conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system for implementing AV training in a synthetic environment, according to some aspects of the present disclosure;

FIG. 2 illustrates another example system for implementing AV training in a synthetic environment, according to some aspects of the present disclosure;

FIG. 3 illustrates an example of a process for implementing an AV training scenario for crew members in a synthetic environment, according to some aspects of the present disclosure;

FIG. 4 illustrates an example of a process for implementing an AV training scenario for technicians in a synthetic environment, according to some aspects of the present disclosure;

FIG. 5 illustrates an example of a process for AV training in a synthetic environment, according to some aspects of the present disclosure;

FIG. 6 illustrates an example system environment that can be used to facilitate autonomous vehicle (AV) navigation and routing operations, according to some aspects of the present disclosure;

FIG. 7 illustrates an example of a deep learning neural network that can be used to generate training scenarios and synthetic environments, according to some aspects of the present disclosure; and

FIG. 8 illustrates an example processor-based system with which some aspects of the subject technology can be implemented, according to some aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense a surrounding environment and to navigate through the environment without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

As discussed above, autonomous vehicles are designed to navigate autonomously in an environment without human input or intervention. However, AVs can encounter a myriad of scenarios and situations that may require a technician or crew member (also remote advisor (RA), remote operator) to respond and/or intervene. In some instances, RA assistance may be used to help the AV navigate around or through an unknown or difficult obstacle or situation. In other instances, RA assistance may be required to facilitate servicing or repairs to the AV. As discussed in further detail below, RA assistance in a synthetic environment may also be used to facilitate the training or education of technicians or other AV operators, for example, regarding various AV systems and/or repair/maintenance operating procedures.

In situations where an AV may encounter an environmental scenario that hinders the vehicle from autonomously navigating. For example, there may be an obstruction in front of the vehicle including, but not limited to a tree, pothole or any object that the AV is unable to maneuver around without RA intervention (e.g., an RA may remotely communicate with the AV and navigate the AV around the obstruction or communicate with an individual inside the AV with instructions to navigate around the obstruction). In another example, an AV may encounter an unusual weather scenario (e.g., heavy snow, rain, and/or fog, etc.) that can cause the vehicle to fail which may require RA intervention. In service-related scenarios, RA intervention may be used to facilitate efforts by an on-site operator to clean or repair the AV. For example, a passenger may have a spill inside the AV that requires a technician to clean the vehicle. In another example, an AV may drive over a nail on the road that requires a technician to repair or change a tire. In another example, an AV may require a battery change which can require more than one technician. In such instances, RA intervention may be used to provide guidance or information to an on-site operator or technician, e.g., to facilitate quick and complete servicing of the AV, which may be necessary to return the AV to safe and comfortable operation. Those skilled in the art will appreciate additional examples of AV scenarios and situations that may require one or more technicians or RAs to intervene. In order to intervene and assist with an AV, both RAs and technicians need training and the requisite skillset to deal with the situation. In some cases, training can be difficult to setup as certain real-world scenarios do not occur frequently. For example, there may be a rare weather condition that is difficult to train for due to infrequent occurrences in the real-world. Furthermore, there may be scenarios and situations that require intervention from a particular technician or RA in another geographic location from where the AV is located.

Aspects of the disclosed invention provide solutions for training technicians and crew members to experience and resolve real-world scenarios and situations that an AV may encounter. More specifically, aspects of the disclosed invention provide solutions for training technicians and crew members in a synthetic environment. As described herein, a synthetic environment may represent a virtual world that mimics aspects of the physical world using technologies including, but not limited to, virtual reality (VR), augmented reality (AR), and artificial intelligence (AI). Additional examples of a synthetic environment may include a metaverse (e.g., the internet as an immersive, virtual world), a virtual environment (e.g., synthetic environment using VR), and a video game environment (e.g., a synthetic environment focused on gaming applications). Those skilled in the art will appreciate additional examples of synthetic environments. A user may access a synthetic environment using a remote device. Examples of a remote device may include, but are not limited to, a headset, wearable device, eyewear, a controller, and/or a holographic system (e.g., a holographic system can display a digital representation of an environment without the need for a wearable device). In some aspects, audio, video and haptic feedback data from a synthetic environment may be received by the user. In some aspects, a synthetic environment may be used by technicians, crew members and additional personnel for various types of training. For example, there may be training for AV failure modes, AV training for law enforcement and emergency personnel, training for pit crew, training programs for various weather conditions and different markets (e.g., different geolocations), training to resolve AV issues with technicians in more than one geographic location, training for AV maneuver recommendations, and/or training for customers regarding how to access or operate the vehicle, and/or training for ways in which cargo or other items may be loaded into the AV. In another example, the synthetic environment may be used to interview and evaluate individuals for potential job opportunities. In some aspects, synthetic environment training may be interactive and allow for multiple users to simultaneously work on the same training program.

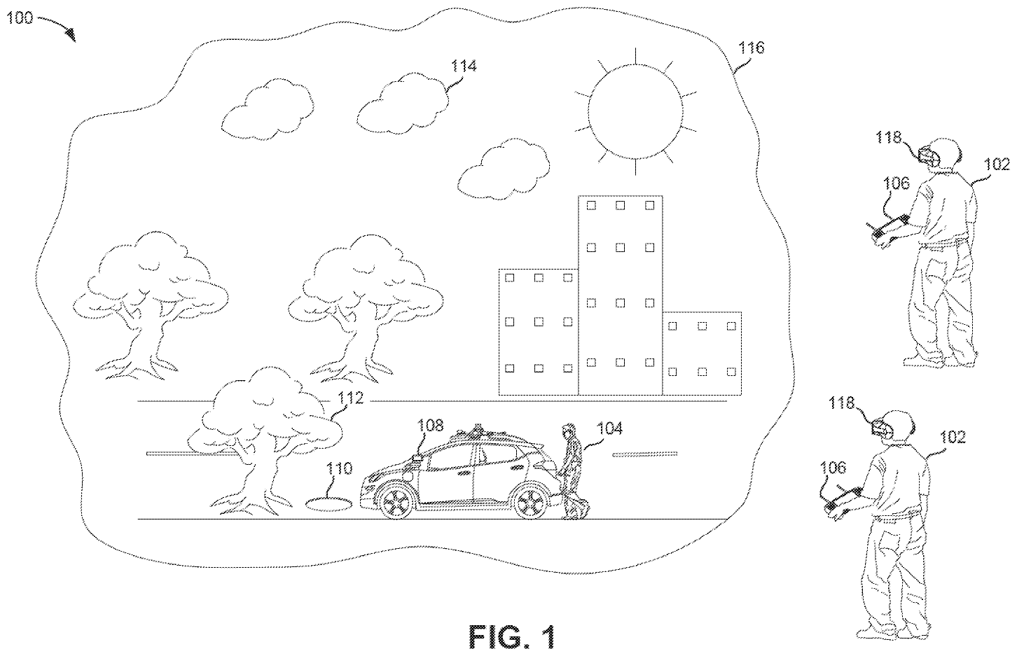

FIG. 1 illustrates an example of a training scenario (also training program) 100 in which AV training in a synthetic environment (e.g., synthetic environment 116) may be implemented. Training scenario 100 includes synthetic environment 116, one or more users (also RA, crew member, technician, trainee) 102, one or more remote devices (also device, virtual reality device, headset, wearable device) 118, one or more external vehicle controllers (also XVC, controller, remote controller) 106, AV 108, first obstruction 110, second obstruction 112, one or more virtual users (also avatar, digital representation, digital asset) 104, and weather condition (also weather event) 114. In some aspects, synthetic environment 116 may include a scene (e.g., as illustrated by the region internal to synthetic environment 116) representative of a specific training scenario 100. The illustration as shown in FIG. 1 internal to synthetic environment 116 is only one example representative of one training scenario 100. There may be any scene internal to synthetic environment 116 which may be used as a training tool for users 102. For example, synthetic environment 116 may include a scene representative of a training scenario 100 for a trainee 102 to experience and resolve typical real-world issues and scenarios that a real-world AV (not illustrated) may face in the real-world. In other words, synthetic environment 116 can simulate a real-world environment and contain digital assets (also three-dimensional assets) that function equivalently or similar to their respective real-world counterparts (e.g., AV 108 is a digital representation of a real-world AV with all the same parts, hardware, and software).

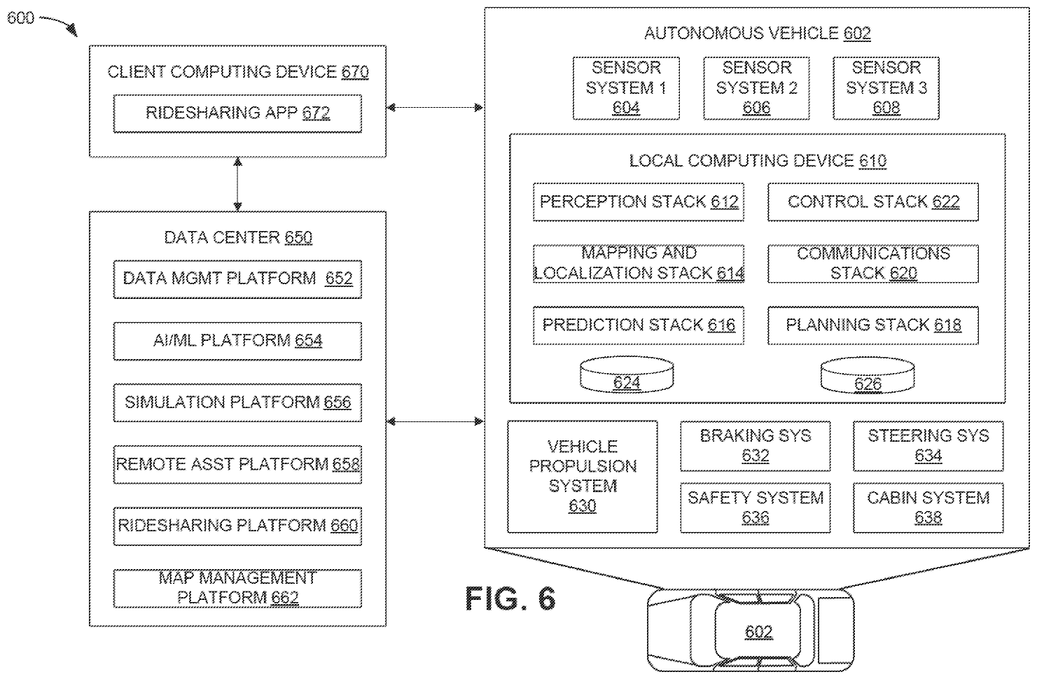

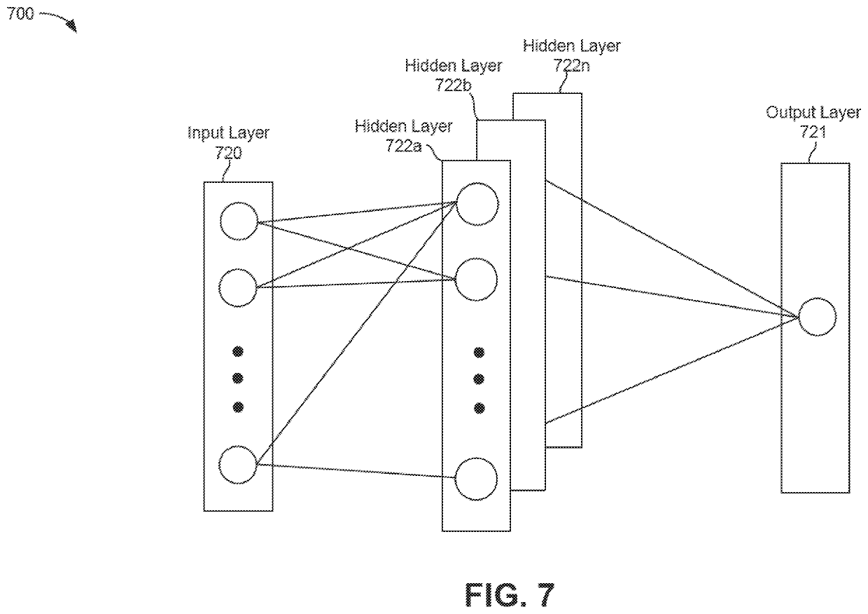

In some cases, synthetic environment 116 may be generated or constructed from road data which can represent a real-world environment. For example, road data may include all the sensor data (e.g., LiDAR, RADAR, ultrasonic, IMU, GNSS as illustrated by sensor systems 604, 606 and 608 in FIG. 6) and the pose (e.g., pitch, roll, yaw) of a real-world AV (not illustrated) in three-dimensional (3D) space and the map data of the surrounding environment (e.g., the environment around the real-world AV). As a result, a virtual or synthetic environment may be generated using the road data which can be a recording of what a real-world AV “saw” while it was driving around a real-world environment. In addition, machine learning (ML) algorithms (e.g., neural network 700 which will be discussed in further detail in FIG. 7 below) may be used to enhance synthetic environment 116 by adding additional digital assets on top of the road data. For example, ML algorithms may add additional structures, objects, people and other digital assets to synthetic environment 116. In some instances, digital 3D assets may also be added to synthetic environment 116 without the use of ML algorithms (e.g., via a set of instructions from user 102 or from another source not illustrated in FIG. 1). In another example, synthetic environment 116 may be generated without road data. For example, synthetic environment 116 may be generated entirely by ML algorithms, software or code that does not include real-world sensor data.

As discussed above, training scenario 100 can be used by technicians, crew members and additional personnel to solve various problems and issues with “hands on” (e.g., using synthetic environment 116) training. Since training scenario 100 uses a synthetic environment 116, training can be achieved without the use of real-world assets (e.g., a real-world AV and environment). A user 102 may interact with the synthetic environment 116 via remote device 118. Remote device 118 may communicate with synthetic environment 116 via a wireless connection including, but not limited to, a WIFI network connection, a mobile or cellular network connection, Bluetooth®, or internet connection. In some examples, remote device 118 may be a wearable device for user 102 that enables user 102 to interact with synthetic environment 116. In another example, remote device 118 may be a holographic display system that enables the user to interact with synthetic environment 116. In some cases, user 102 may interact (e.g., provide user input), communicate, send instructions or send data to synthetic environment 116 with remote device 118. For example, remote device 118 may include a bodysuit, glove, headset with eye-tracking, or any device capable of receiving input from user 102. Those skilled in the art will appreciate additional examples of remote devices 118 that can enable user 102 to interact (e.g., either passively by only receiving data or actively by receiving and transmitting data) with synthetic environment 116. Interacting with synthetic environment 116 may include controlling the digital assets (e.g., also adding or removing) or any object inside synthetic environment 116. User 102 may also interact with synthetic environment 116 via the use of external vehicle controller 106. For example, external vehicle controller 106 may enable user 102 to control and move AV 108 within synthetic environment 116. User 102 may also have a digital representation 104 of themselves represented within synthetic environment 116. For example, one user 102 may have a digital representation 104 inside synthetic environment 116 communicating with another user 102 in the same synthetic environment 116 that may or may not have a digital representation 104. A digital representation 104 of a user 102 may interact within synthetic environment 116 in the same manner as how a user 102 would interact in areal-world environment.

In one training scenario 100, user 102 can be a crew member where AV 108 is stuck (e.g., no longer navigating autonomously) behind a second obstruction (e.g., tree) 112. In other words, AV 108 may be unable to maneuver autonomously around second obstruction 112. The user 102 may control AV 108 (e.g., send instructions to AV's 108 local computing device 610) to maneuver around second obstruction 112 via controller 106 or remote device 118. For example, user 102 may use a microphone on remote device 118 to verbally transmit instructions to AV 108 to maneuver around second obstruction 112. In addition, user 102 may use some features of controller 106 including, but not limited to, directional pads, multiple buttons, analog sticks, joysticks, motion detection, touch screens to maneuver AV 108. In another training scenario 100, user 102 can be a crew member where AV 108 is stuck behind a first obstruction 110 (e.g., pothole). In this example, AV 108 may be able to safely drive over or around first obstruction 110. However, AV's 108 perception stack (e.g., perception stack 616 as discussed below in FIG. 6) may “see” the first obstruction 110 as an obstruction that AV 108 cannot safely navigate around and consequently prevent AV 108 from navigating autonomously. In this training scenario 100, user 102 may override AV's 108 perception stack to remove the first obstruction 110 and consequently enable AV 108 to autonomously navigate over or around it. In some cases, there may be another user 102 in synthetic environment 116 as a digital representation 104 controlling AV 108 that can receive instructions to maneuver AV 108. In another training scenario 100, user 102 can be a technician working to resolve an issue with AV 108. For example, user 102 can be represented by digital representation 104 training to change a battery for AV 108. In this training scenario 100, more than one user 102 may be required to change the battery. Another user 102 as another digital representation 104 may also share the same synthetic environment 116 (e.g., same training scenario 100) to change the battery for AV 108. In some cases, each user 102 does not need to share the same geolocation to access the same training scenario 110 and synthetic environment 116. In another training scenario 100, synthetic environment 116 may simulate a low frequency event that does not occur often in the real-world. For example, there may be a rare weather condition 114 that is impacting AV 108. In this example, user 102 may train for resolving specific issues or failure modes with AV 108 under weather condition 114. There are many more additional example training scenarios 100 that can be implemented with different respective synthetic environments 116. Additional examples may include, but are not limited to, training for first responders, training for law enforcement, training for customers (e.g., users of a real-world AV), training for third-party operators, training for pit-crew (e.g., pit-crew can respond to specific scenarios such as cleaning, towing and recovery, troubleshooting, inspections), and training for job applicants (e.g., training programs that can evaluate an applicant's skillset). Those skilled in the art will appreciate many additional training scenarios 110 and respective synthetic environments 116 that can be developed. In some aspects, the results and outcomes of various training scenarios 100 and synthetic environments 116 may impact real-world AVs (e.g., software within local computing device 610). For example, a training scenario 100 with a particular weather condition 114 may illustrate that a particular sensor parameter is affected and must be calibrated according to that weather condition 114. As a result, the software of a real-world AV may be updated accordingly for that particular sensor parameter operating in a real-world weather condition similar to weather condition 114 of the synthetic environment 116. Furthermore, machine learning algorithms may be used to develop adaptive training programs 100 based on fleet-market data (e.g., real-world AV fleet data). For example, training scenarios 100 may be developed in different markets with similar real-world weather conditions (e.g., if a particular sensor is failing in one geolocation, then additional training scenarios 100 may be developed in other geolocations that share similar real-world weather conditions).

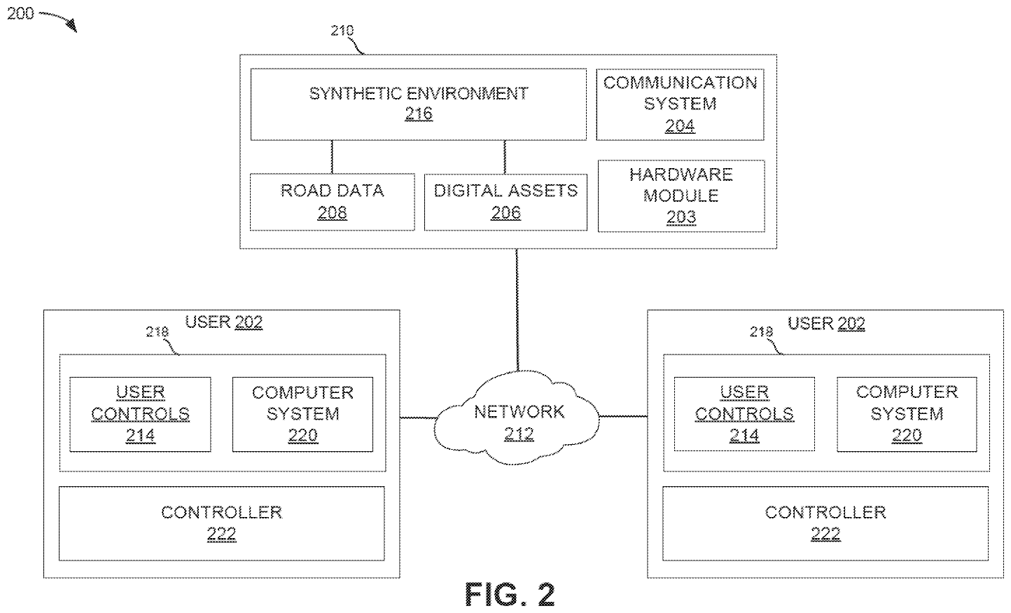

FIG. 2 illustrates another example of a training scenario 200 in which an AV training in a synthetic environment 216 process may be implemented. Training scenario 200 includes computer system 210 which includes synthetic environment 216, road data 208, digital assets 206, communication system 204, and hardware module 203. In addition, training scenario 200 includes one or more users 202 which each include remote device 218 and controller 222. Remote device 218 includes user controls 214 and computer system 220. Computer system 210 and computer system 220 may exchange information (i.e., send and receive data) over a network 212 (e.g., WIFI, cellular, and Bluetooth® as discussed in further detail in FIG. 6 below). In some cases, network 212 may have internet connectivity. Communication system 204 may include a WIFI antenna, cellular antenna, Bluetooth®, or a combination thereof to communicate with a communication system (not shown) internal to computer system 220.

The computer system's 210 hardware module 203 may include all the hardware and software necessary to generate synthetic environment 216 (e.g., software elements for a synthetic environment 216 for any given training scenario 200). For example, road data 208 and digital assets 206 may be stored in hardware module 203. In some aspects, computer system 210 may receive software (e.g., via communication system 204) via network 212 or a direct connection which can be used to generate synthetic environment 216. Synthetic environment 216 may have access to a software repository of road data 208 and digital assets 206. As discussed above in FIG. 1, road data 208 may include all the sensor data and the pose of a real-world AV's (not illustrated) 3D space and the map data of the surrounding environment. Road data 208 may include a repository of present and past data for a fleet of autonomous vehicles. In addition, digital assets 206 may include a software repository of objects (e.g., all the elements to generate multiple environments or scenes for different training scenarios 200) to include in synthetic environment 216. Both road data 208 and digital assets 206 can also be received by computer system 210 (e.g., via communication system 204) from an external source such as computer system 220 or another computer system not shown in FIG. 2.

The user's 202 remote device 218 can include user controls 214 which can adjust different settings of remote device 218. As discussed above, examples of remote device 218 may include, but are not limited to, a headset, wearable device, and a holographic display system. For example, visual and display settings including, but not limited to, sharpness, picture mode, backlight, contrast, brightness, color, hue, gamma, tint, and picture size may be adjusted via user controls 214. In addition, user controls 214 can adjust the volume of the audio data received (e.g., remote device 218 may include a speaker to output audio data to user 202) from synthetic environment 216. In addition, user controls 214 can adjust the volume of the audio data for specific digital assets 206 or objects in synthetic environment 216 (e.g., user 202 may want to only increase the volume from another user 202 in synthetic environment 216 and decrease the volume of ambient noise such as weather or other events in the scene). In some cases, if remote device 218 is a holographic display system, user 202 may adjust the position and size of the received synthetic environment 216 scene in the user's 202 real-world environment. The remote device 218 may also include haptic feedback which enables the user 202 to “feel” the scene of synthetic environment 216. For example, if a user 202 is wearing a remote device 218 that is a haptic bodysuit, the user 202 may physically interact with the environment of synthetic environment 216 and receive haptic feedback (e.g., if user 202 shakes hands with another user 202 in synthetic environment 216, haptic feedback may be received by user 202 in the real-world). The user controls 214 may adjust the intensity of the received haptic feedback. The remote device 218 may also include a microphone (e.g., user controls 214 may adjust the microphone settings) to receive audio data from user 202 which can be transmitted to synthetic environment 216 (e.g., via computer system 220). The computer system 220 can include all the software and hardware necessary to support the operation of remote device 218, including the communication system to transmit and receive data (e.g., via network 212 to communication system 204). Controller 222 may have controls (e.g., toggles, switches, and buttons) which can be used by user 202 to control various objects in synthetic environment 216. For example, user 202 may use controller 222 to control an autonomous vehicle in synthetic environment 216. The user 202 may also add or remove objects (e.g., digital assets 206) in synthetic environment 216 via controller 222 or the user controls 214 of remote device 218.

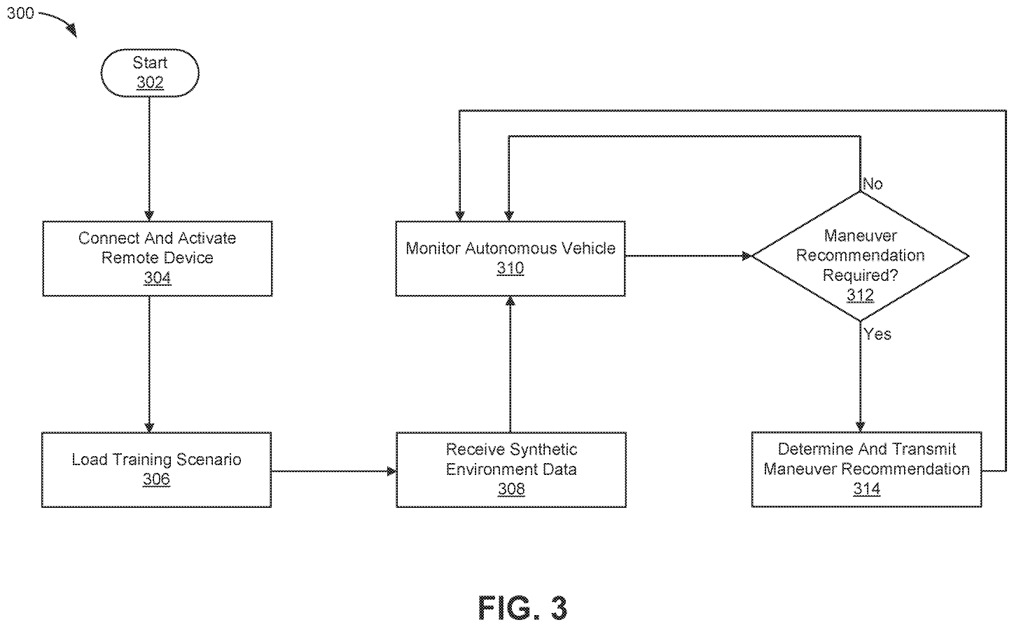

FIG. 3 illustrates an example of a process 300 for implementing an AV training scenario for crew members in a synthetic environment. In some examples, the process 300 may start at step 302 for a user (e.g., user 102) such as a crew member to begin working on a training scenario (e.g., training scenario 100) in which an AV may be stuck behind an obstruction in the synthetic environment (e.g., AV 108 stuck behind first obstruction 110 or second obstruction 112 in synthetic environment 116).

At step 304, the crew member may connect and activate a remote device (e.g., remote device 118) to begin interacting with the training scenario in the synthetic environment. For example, the crew member can turn the power on for the remote device and attach the remote device as necessary (e.g., wear a headset or bodysuit).

At step 306, the crew member can load a training scenario. For example, computer system 210 can include a repository of software (e.g., road data 208, digital assets 206, and additional software) to generate a synthetic environment for a particular training scenario. In some cases, machine learning algorithms may be used to generate the synthetic environment (which will be discussed in further detail in FIG. 7 below) for a training scenario. As illustrated in FIG. 3, process 300 is a training scenario for an autonomous vehicle maneuver recommendation.

At step 308, the crew member can receive synthetic environment 116 data. The crew member's remote device 118 may receive visual, audio and haptic feedback data. For example, if the crew member is wearing a headset, visual and audio data can be seen and heard via a screen and speakers on the headset. In another example, if the remote device is a wearable device with haptic feedback capability such as a glove or bodysuit, then vibration patterns or other mechanical and sensory feedback can be received by the crew member.

At step 310, the crew member can monitor the autonomous vehicle in the synthetic environment. For example, the crew member can view the synthetic environment 116 via remote device 118 and monitor the autonomous vehicle's 108 behavior and check if there is an issue that may require assistance.

At step 312, the process 300 determines whether a maneuver recommendation is required. For example, AV 108 may be stuck behind a pothole or tree (e.g., first obstruction 110 or second obstruction 112). If a determination is made that a maneuver recommendation is not required, the process 300 returns to step 310 to continue monitoring the autonomous vehicle in the synthetic environment. Alternatively, if a determination is made that a maneuver recommendation is required, the process 300 continues to step 314.

At step 314, the crew member can determine and transmit a maneuver recommendation to the AV. For example, if AV 108 is stuck behind a tree (e.g., second obstruction 112) and is unable to autonomously maneuver around the obstruction, then the crew member may send instructions (e.g., via a microphone on remote device 118 or via controls on controller 106) to navigate around the tree. In some aspects, the crew member may send instructions to another user within the same synthetic environment 116 to maneuver around the tree. In another example, if AV 108 is stuck behind a pothole (e.g., first obstruction 110) and the crew member determines the AV can safely drive over it, then they may override AV 108's perception (e.g., perception stack 612) to remove the pothole from the AV's “vision” so that the AV can autonomously navigate over it.

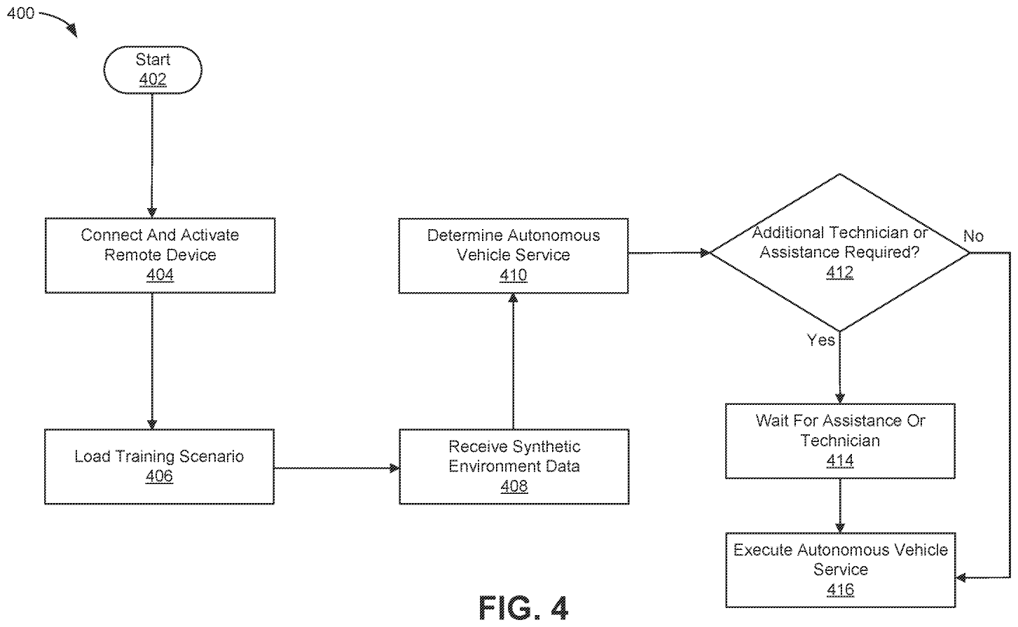

FIG. 4 illustrates an example of a process 400 for implementing an AV training scenario for technicians in a synthetic environment. In some examples, the process 400 may start at step 402 for a user (e.g., user 102) such as a technician to begin working on a training scenario (e.g., training scenario 100) in which an AV (e.g., AV 108) requires servicing such as a battery change, tire repair, or any other issue requiring a technician.

At step 404, the technician may connect and activate a remote device (e.g., remote device 118) to begin interacting with the training scenario in the synthetic environment 116 (e.g., a metaverse environment). For example, the technician can turn the power on for the remote device and attach the remote device as necessary (e.g., wear a headset or bodysuit). As discussed above, remote device 118 may include a controller, such as a joystick and/or other actuatable controls that can be used for manipulating various AV operations or systems, such as by controlling AV controller outputs to change a navigation trajectory or kinematic outputs (e.g., velocities, trajectories, etc.).

At step 406, the technician can load a training scenario. For example, computer system 210 can include a repository of software (e.g., road data 208, digital assets 206, and additional software) to generate a synthetic environment for a particular training scenario. In some cases, machine learning algorithms may be used to generate a synthetic environment (which will be discussed in further detail in FIG. 7 below) for a training scenario. Those skilled in the art will appreciate different training scenarios for autonomous vehicle technicians.

At step 408, the technician can receive synthetic environment 116 data. The technician's remote device 118 may receive visual, audio and haptic feedback data. For example, if the technician is wearing a headset, visual and audio data can be seen and heard via a screen and speakers on the headset. In another example, if the remote device is a wearable device with haptic feedback capability such as a glove or bodysuit, then vibration patterns or other mechanical and sensory feedback can be received by the technician. In some cases, since the technician needs to work on a servicing for the AV, the technician can be represented as an avatar 104 in the synthetic environment 116 which can interact with the AV. The technician may sense haptic feedback as they are servicing the AV in the synthetic environment.

At step 410, the technician can determine the AV service required. For example, if a training scenario that was loaded as step 406 does not indicate the servicing required for the AV (e.g., part of the training is for the technician to determine the requisite training), then the technician may interact (e.g., via avatar 104) with AV to ascertain the necessary service needed.

At step 412, process 400 determines whether an additional technician or assistance is required. For example, the technician may need to change the battery on the AV which may require an additional technician (e.g., as another avatar 104) to aid in the servicing. In another example, the technician may need assistance from another technician, crew member or service advisor to help with a particular service. For example, there may be a complicated servicing required for the AV for which the technician needs assistance from an expert. In some cases, the expert may be in any geolocation (e.g., not in the same geolocation as the technician) and provide instructions to the technician via the remote device (e.g., audio or video data to the remote device) or directly in the synthetic environment (e.g., audio or video data observable by the technician's avatar). If a determination is made that an additional technician is required, the process moves to step 414 to wait for assistance. However, if a determination is made than the technician does not need assistance, the process can continue to step 416 where the technician can execute the AV servicing.

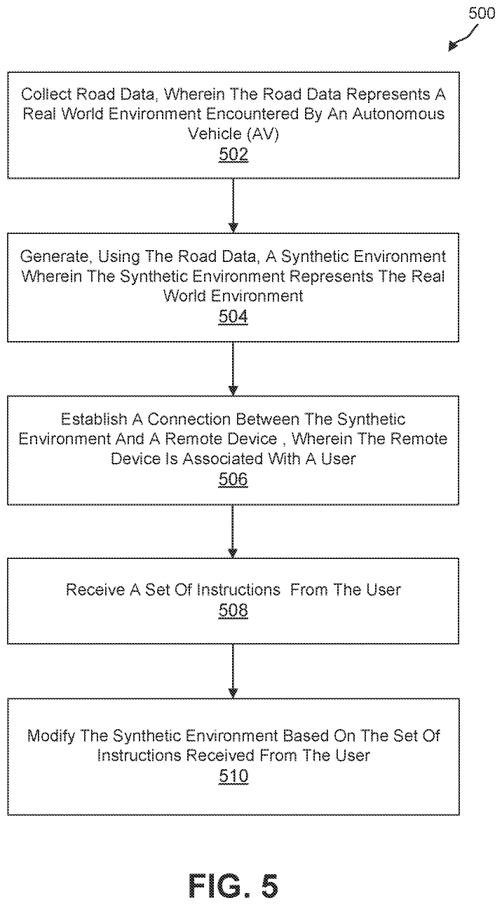

FIG. 5 illustrates an example of a process 500 for AV training in a synthetic environment. At block 502, process 500 includes collecting road data, wherein the road data represents a real-world environment encountered by an autonomous vehicle. For example, a real-world autonomous vehicle can capture (e.g., using sensor systems 604, 606 and 608) road data 208 in a real-world environment which can be used to generate synthetic environment 116.

At block 504, process 500 includes generating, using the road data, a synthetic environment wherein the synthetic environment represents the real-world environment. For example, the road data captured by real-world autonomous vehicles can be used to generate synthetic environment 116.

At block 506, process 500 includes establishing a connection between the synthetic environment and a remote device, wherein the remote device is associated with a user. For example, remote device 118 can connect to synthetic environment 116 via network connection 212.

At block 508, the process 500 includes receiving a set of instructions from the user. For example, the user 102 can transmit instructions to synthetic environment 116 via remote device 118 or controller 106. In some aspects, if remote device 118 is a headset, user 102 may use voice commands to transmit instructions to synthetic environment 116. In another example, if remote device 118 is a bodysuit, gloves, or wearable device, user 102 may transmit instructions to synthetic environment 116 through physical movement (e.g., hand and body gestures).

At block 510, the process 500 includes modifying the synthetic environment based on the set of instructions received from the user. For example, based on the received instructions from user 102, synthetic environment 116 may change. The user 102 may control AV 108 in synthetic environment 116 via remote device 118 or controller 106.

FIG. 6 illustrates an example of an AV management system 600. One of ordinary skill in the art will understand that, for the AV management system 600 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill in the art will appreciate that such variations do not depart from the scope of the present disclosure.

In this example, the AV management system 600 includes an AV 602, a data center (also autonomous vehicle fleet management device, autonomous vehicle fleet management system, management system) 650, and a client computing device 670. The AV 602, the data center 650, and the client computing device 670 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 602 can navigate roadways without a human driver based on sensor signals generated by multiple sensor systems 604, 606, and 608. The sensor systems 604-608 can include different types of sensors and can be arranged about the AV 602. For instance, the sensor systems 604-608 can comprise Inertial Measurement Units (IMUs), cameras (e.g., still image cameras, video cameras, etc.), light sensors (e.g., LiDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 can be a camera system, the sensor system 606 can be a LiDAR system, and the sensor system 608 can be a RADAR system. Other embodiments may include any other number and type of sensors.

The AV 602 can also include several mechanical systems that can be used to maneuver or operate the AV 602. For instance, the mechanical systems can include a vehicle propulsion system 630, a braking system 632, a steering system 634, a safety system 636, and a cabin system 638, among other systems. The vehicle propulsion system 630 can include an electric motor, an internal combustion engine, or both. The braking system 632 can include an engine brake, brake pads, actuators, and/or any other suitable componentry configured to assist in decelerating the AV 602. The steering system 634 can include suitable componentry configured to control the direction of movement of the AV 602 during navigation. The safety system 636 can include lights and signal indicators, a parking brake, airbags, and so forth. The cabin system 638 can include cabin temperature control systems, in-cabin entertainment systems, and so forth. In some embodiments, the AV 602 might not include human driver actuators (e.g., steering wheel, handbrake, foot brake pedal, foot accelerator pedal, turn signal lever, window wipers, etc.) for controlling the AV 602. Instead, the cabin system 638 can include one or more client interfaces (e.g., Graphical User Interfaces (GUIs), Voice User Interfaces (VUIs), etc.) for controlling certain aspects of the mechanical systems 630-638.

The AV 602 can additionally include a local computing device 610 that is in communication with the sensor systems 604-608, the mechanical systems 630-638, the data center 650, and the client computing device 670, among other systems. The local computing device 610 can include one or more processors and memory, including instructions that can be executed by the one or more processors. The instructions can make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a prediction stack 616, a planning stack 618, a communications stack 620, a control stack 622, an AV operational database 624, and an HD geospatial database 626, among other stacks and systems.

The perception stack 612 can enable the AV 602 to “see” (e.g., via cameras, LiDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 626, other components of the AV, and other data sources (e.g., the data center 650, the client computing device 670, third party data sources, etc.). The perception stack 612 can detect and classify objects and determine their current locations, speeds, directions, and the like. In addition, the perception stack 612 can determine the free space around the AV 602 (e.g., to maintain a safe distance from other objects, change lanes, park the AV, etc.). The perception stack 612 can also identify environmental uncertainties, such as where to look for moving objects, flag areas that may be obscured or blocked from view, and so forth. In some embodiments, an output of the prediction stack 616 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 614 can determine the AV's position and orientation (pose) using different methods from multiple systems (e.g., GPS, IMUs, cameras, LiDAR, RADAR, ultrasonic sensors, the HD geospatial database 626, etc.). For example, in some embodiments, the AV 602 can compare sensor data captured in real-time by the sensor systems 604-608 to data in the HD geospatial database 626 to determine its precise (e.g., accurate to the order of a few centimeters or less) position and orientation. The AV 602 can focus its search based on sensor data from one or more first sensor systems (e.g., GPS) by matching sensor data from one or more second sensor systems (e.g., LiDAR). If the mapping and localization information from one system is unavailable, the AV 602 can use mapping and localization information from a redundant system and/or from remote data sources.

The prediction stack 616 can receive information from the mapping and localization stack 614 and objects identified by the perception stack 612 and predict a future path for the objects. In some embodiments, the prediction stack 616 can output several likely paths that an object is predicted to take along with a probability associated with each path. For each predicted path, the prediction stack 616 can also output a range of points along the path corresponding to a predicted location of the object along the path at future time intervals along with an expected error value for each of the points that indicates a probabilistic deviation from that point.

The planning stack 618 can determine how to maneuver or operate the AV 602 safely and efficiently in its environment. For example, the planning stack 618 can receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 602 from one point to another and outputs from the perception stack 612, mapping and localization stack 614, and prediction stack 616. The planning stack 618 can determine multiple sets of one or more mechanical operations that the AV 602 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 618 can select from multiple backup plans to carry out. For example, while preparing to change lanes to turn right at an intersection, another vehicle may aggressively cut into the destination lane, making the lane change unsafe. The planning stack 618 could have already determined an alternative plan for such an event. Upon its occurrence, it could help direct the AV 602 to go around the block instead of blocking a current lane while waiting for an opening to change lanes.

The control stack 622 can manage the operation of the vehicle propulsion system 630, the braking system 632, the steering system 634, the safety system 636, and the cabin system 638. The control stack 622 can receive sensor signals from the sensor systems 604-608 as well as communicate with other stacks or components of the local computing device 610 or a remote system (e.g., the data center 650) to effectuate operation of the AV 602. For example, the control stack 622 can implement the final path or actions from the multiple paths or actions provided by the planning stack 618. This can involve turning the routes and decisions from the planning stack 618 into commands for the actuators that control the AV's steering, throttle, brake, and drive unit.

The communications stack 620 can transmit and receive signals between the various stacks and other components of the AV 602 and between the AV 602, the data center 650, the client computing device 670, and other remote systems. The communications stack 620 can enable the local computing device 610 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 620 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 626 can store HD maps and related data of the streets upon which the AV 602 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 624 can store raw AV data generated by the sensor systems 604-608, stacks 612-622, and other components of the AV 602 and/or data received by the AV 602 from remote systems (e.g., the data center 650, the client computing device 670, etc.). In some embodiments, the raw AV data can include HD LiDAR point cloud data, image data, RADAR data, GPS data, and other sensor data that the data center 650 can use for creating or updating AV geospatial data or for creating simulations of situations encountered by AV 602 for future testing or training of various machine learning algorithms that are incorporated in the local computing device 610.

The data center 650 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 650 can include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 can send and receive various signals to and from the AV 602 and the client computing device 670. These signals can include sensor data captured by the sensor systems 604-608, roadside assistance requests, software updates, ridesharing pick-up and drop-off instructions, and so forth. In this example, the data center 650 includes a data management platform 652, an Artificial Intelligence/Machine Learning (AI/ML) platform 654, a simulation platform 656, a remote assistance platform 658, a ridesharing platform 660, and a map management platform 662, among other systems.

The data management platform 652 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 can access data stored by the data management platform 652 to provide their respective services.

The AI/ML platform 654 can provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists can prepare data sets from the data management platform 652; select, design, and train machine learning models; evaluate, refine, and deploy the models; maintain, monitor, and retrain the models; and so on.

The simulation platform 656 can enable testing and validation of the algorithms, machine learning models, neural networks, and other development efforts for the AV 602, the remote assistance platform 658, the ridesharing platform 660, the map management platform 662, and other platforms and systems. The simulation platform 656 can replicate a variety of driving environments and/or reproduce real-world scenarios from data captured by the AV 602, including rendering geospatial information and road infrastructure (e.g., streets, lanes, crosswalks, traffic lights, stop signs, etc.) obtained from a cartography platform (e.g., map management platform 662); modeling the behavior of other vehicles, bicycles, pedestrians, and other dynamic elements; simulating inclement weather conditions, different traffic scenarios; and so on.

The remote assistance platform 658 can generate and transmit instructions regarding the operation of the AV 602. For example, in response to an output of the AI/ML platform 654 or other system of the data center 650, the remote assistance platform 658 can prepare instructions for one or more stacks or other components of the AV 602.

The ridesharing platform 660 can interact with a customer of a ridesharing service via a ridesharing application 672 executing on the client computing device 670. The client computing device 670 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 672. The client computing device 670 can be a customer's mobile computing device or a computing device integrated with the AV 602 (e.g., the local computing device 610). The ridesharing platform 660 can receive requests to pick up or drop off from the ridesharing application 672 and dispatch the AV 602 for the trip.

Map management platform 662 can provide a set of tools for the manipulation and management of geographic and spatial (geospatial) and related attribute data. The data management platform 652 can receive LiDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data can be processed, and map management platform 662 can render base representations (e.g., tiles (2D), bounding volumes (3D), etc.) of the AV geospatial data to enable users to view, query, label, edit, and otherwise interact with the data. Map management platform 662 can manage workflows and tasks for operating on the AV geospatial data. Map management platform 662 can control access to the AV geospatial data, including granting or limiting access to the AV geospatial data based on user-based, role-based, group-based, task-based, and other attribute-based access control mechanisms. Map management platform 662 can provide version control for the AV geospatial data, such as to track specific changes that (human or machine) map editors have made to the data and to revert changes when necessary. Map management platform 662 can administer release management of the AV geospatial data, including distributing suitable iterations of the data to different users, computing devices, AVs, and other consumers of HD maps. Map management platform 662 can provide analytics regarding the AV geospatial data and related data, such as to generate insights relating to the throughput and quality of mapping tasks.

In some embodiments, the map viewing services of map management platform 662 can be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit en route to a pick-up or drop-off location, and so on.

In FIG. 7, the disclosure now turns to a further discussion of models that can be used through the environments and techniques described herein. FIG. 7 illustrates an example of a deep learning neural network 700 that can be used to implement all or a portion of the solutions described herein. For example, neural network 700 can be used to implement a perception module (or perception system) as discussed above. In another example, neural network 700 can be used to generate training scenarios and synthetic environments. For example, neural network 700 may use road data, digital assets, or other software to create training scenarios and associated synthetic environments. In some examples, neural network 700 may be implemented at AV 602, data center 650, and/or client computing device 670.

In some examples, an input layer 720 can be configured to receive sensor data and/or data relating to an environment surrounding an AV. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 721 that provides an output resulting from the processing performed by the hidden layers 722a, 722b, through 722n. In one illustrative example, the output layer 721 can provide estimated treatment parameters, that can be used/ingested by a differential simulator to estimate a patient treatment outcome.

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

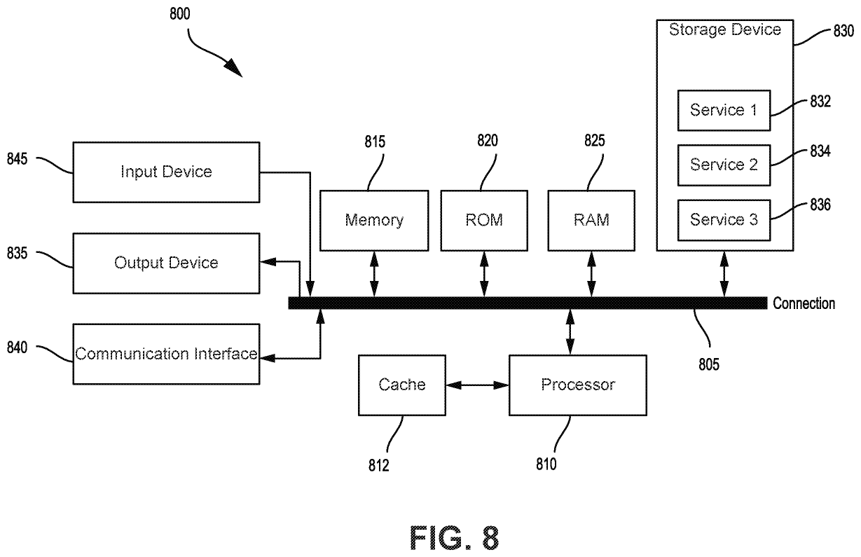

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Aspect 1. An apparatus, comprising: at least one memory; and at least one processor coupled to the at least one memory, the at least one processor configured to: collect road data, wherein the road data represents a real-world environment encountered by an autonomous vehicle (AV); generate, using the road data, a synthetic environment wherein the synthetic environment represents the real-world environment; establish a connection between the synthetic environment and a remote device, wherein the remote device is associated with a user; receive a set of instructions from the user; and modify the synthetic environment based on the set of instructions received from the user.

Aspect 2. The apparatus of Aspect 1, wherein the set of instructions received from the user comprises a modified AV route.

Aspect 3. The apparatus of any of Aspects 1-2, wherein the set of instructions comprises a perception layer override.

Aspect 4. The apparatus of any of Aspects 1-3, wherein the set of instructions comprises a command to add one or more three-dimensional (3D) assets to the synthetic environment.

Aspect 5. The apparatus of any of Aspects 1-4, wherein the synthetic environment includes a synthetic autonomous vehicle.

Aspect 6. The apparatus of Aspect 5, wherein the at least one processor is further configured to: establish a connection between the synthetic environment and an external vehicle controller, wherein the external vehicle controller is associated with the user and wherein the external vehicle controller controls the synthetic autonomous vehicle.

Aspect 7. The apparatus of any of Aspects 1-6, wherein the remote device comprises at least one of a headset, wearable device, holographic display system, or a combination thereof.

Aspect 8. A computer-implemented method comprising: collecting road data, wherein the road data represents a real-world environment encountered by an autonomous vehicle (AV); generating, using the road data, a synthetic environment wherein the synthetic environment represents the real-world environment; establishing a connection between the synthetic environment and a remote device, wherein the remote device is associated with a user; receiving a set of instructions from the user; and modifying the synthetic environment based on the set of instructions received from the user.

Aspect 9. The computer-implemented method of Aspect 8, wherein the set of instructions received from the user comprises a modified AV route.

Aspect 10. The computer-implemented method of any of Aspects 8-9, wherein the set of instructions comprises a perception layer override.

Aspect 11. The computer-implemented method of any of Aspects 8-10, wherein the set of instructions comprises a command to add one or more three-dimensional (3D) assets to the synthetic environment.

Aspect 12. The computer-implemented method of any of Aspects 8-11, wherein the synthetic environment includes a synthetic autonomous vehicle.

Aspect 13. The computer-implemented method of Aspect 12, further comprising: establishing a connection between the synthetic environment and an external vehicle controller, wherein the external vehicle controller is associated with the user and wherein the external vehicle controller controls the synthetic autonomous vehicle.

Aspect 14. The computer-implemented method of any of Aspects 8-13, wherein the remote device comprises at least one of a headset, wearable device, holographic display system, or a combination thereof.

Aspect 15. A non-transitory computer-readable storage medium comprising at least one instruction for causing a computer or processor to: collect road data, wherein the road data represents a real-world environment encountered by an autonomous vehicle (AV); generate, using the road data, a synthetic environment wherein the synthetic environment represents the real-world environment; establish a connection between the synthetic environment and a remote device, wherein the remote device is associated with a user; receive a set of instructions from the user; and modify the synthetic environment based on the set of instructions received from the user.

Aspect 16. The non-transitory computer-readable storage medium of Aspect 15, wherein the set of instructions received from the user comprises a modified AV route.

Aspect 17. The non-transitory computer-readable storage medium of any of Aspects 15-16, wherein the set of instructions comprises a perception layer override.

Aspect 18. The non-transitory computer-readable storage medium of any of Aspects 15-17, wherein the set of instructions comprises a command to add one or more three-dimensional (3D) assets to the synthetic environment.

Aspect 19. The non-transitory computer-readable storage medium of any of Aspects 15-18, wherein the synthetic environment includes a synthetic autonomous vehicle.

Aspect 20. The non-transitory computer-readable storage medium of Aspect 19, wherein the at least one instruction is further configured to: establish a connection between the synthetic environment and an external vehicle controller, wherein the external vehicle controller is associated with the user and wherein the external vehicle controller controls the synthetic autonomous vehicle.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus, comprising:
at least one memory; and
at least one processor coupled to the at least one memory, the at least one processor configured to:
collect road data, wherein the road data represents a real-world environment encountered by an autonomous vehicle (AV);
generate, using the road data, a synthetic environment wherein the synthetic environment represents the real-world environment;
establish a connection between the synthetic environment and a remote device, wherein the remote device is associated with a user;
receive a set of instructions from the user; and
modify the synthetic environment based on the set of instructions received from the user.

2. The apparatus of claim 1, wherein the set of instructions received from the user comprises a modified AV route.

3. The apparatus of claim 1, wherein the set of instructions comprises a perception layer override.

4. The apparatus of claim 1, wherein the set of instructions comprises a command to add one or more three-dimensional (3D) assets to the synthetic environment.

5. The apparatus of claim 1, wherein the synthetic environment includes a synthetic autonomous vehicle.

6. The apparatus of claim 5, wherein the at least one processor is further configured to:
establish a connection between the synthetic environment and an external vehicle controller, wherein the external vehicle controller is associated with the user and wherein the external vehicle controller controls the synthetic autonomous vehicle.

7. The apparatus of claim 1, wherein the remote device comprises at least one of a headset, wearable device, holographic display system, or a combination thereof.

8. A computer-implemented method comprising:
collecting road data, wherein the road data represents a real-world environment encountered by an autonomous vehicle (AV);
generating, using the road data, a synthetic environment wherein the synthetic environment represents the real-world environment;
establishing a connection between the synthetic environment and a remote device, wherein the remote device is associated with a user;
receiving a set of instructions from the user; and
modifying the synthetic environment based on the set of instructions received from the user.

9. The computer-implemented method of claim 8, wherein the set of instructions received from the user comprises a modified AV route.

10. The computer-implemented method of claim 8, wherein the set of instructions comprises a perception layer override.

11. The computer-implemented method of claim 8, wherein the set of instructions comprises a command to add one or more three-dimensional (3D) assets to the synthetic environment.

12. The computer-implemented method of claim 8, wherein the synthetic environment includes a synthetic autonomous vehicle.

13. The computer-implemented method of claim 12, further comprising:
establishing a connection between the synthetic environment and an external vehicle controller, wherein the external vehicle controller is associated with the user and wherein the external vehicle controller controls the synthetic autonomous vehicle.

14. The computer-implemented method of claim 8, wherein the remote device comprises at least one of a headset, wearable device, holographic display system, or a combination thereof.

15. A non-transitory computer-readable storage medium comprising at least one instruction for causing a computer or processor to:
collect road data, wherein the road data represents a real-world environment encountered by an autonomous vehicle (AV);
generate, using the road data, a synthetic environment wherein the synthetic environment represents the real-world environment;
establish a connection between the synthetic environment and a remote device, wherein the remote device is associated with a user;
receive a set of instructions from the user; and
modify the synthetic environment based on the set of instructions received from the user.

16. The non-transitory computer-readable storage medium of claim 15, wherein the set of instructions received from the user comprises a modified AV route.

17. The non-transitory computer-readable storage medium of claim 15, wherein the set of instructions comprises a perception layer override.

18. The non-transitory computer-readable storage medium of claim 15, wherein the set of instructions comprises a command to add one or more three-dimensional (3D) assets to the synthetic environment.

19. The non-transitory computer-readable storage medium of claim 15, wherein the synthetic environment includes a synthetic autonomous vehicle.

20. The non-transitory computer-readable storage medium of claim 19, wherein the at least one instruction is further configured to:
establish a connection between the synthetic environment and an external vehicle controller, wherein the external vehicle controller is associated with the user and wherein the external vehicle controller controls the synthetic autonomous vehicle.
